(19) United States
(12) Patent Application Publication
(10) Pub. No.: US 2019/0148814 A1
(43) Pub. Date: May 16, 2019

(54) RFID Gate Antenna

(71) Applicant: Chung-Ping LAI, Hsinchu County (TW)

(72) Inventor: Chung-Ping LAI, Hsinchu County (TW)

(21) Appl. No.: 15/812,699

(22) Filed: Nov. 14, 2017

(51) Int. Cl. H01Q 1/22; H01Q 9/04; H01Q 1/38

(52) U.S. Cl. CPC H01Q 1/2216; H01Q 1/38; H01Q 9/0407

(57) ABSTRACT

A radio-frequency identification (RFID) gate antenna is revealed. The RFID gate antenna includes a dielectric layer, a patch layer and a ground layer. The dielectric layer is a sheet-like part made from dielectric material and having an inner surface and an opposite outer surface. The inner surface is a surface located on one side of the dielectric layer and facing the center of curvature. The patch layer including a feed point is attached to the inner surface of the dielectric layer. The ground layer is attached to the outer surface of the dielectric layer, opposite to the patch layer. The RFID gate antenna features on modification of detecting angle and directivity thereof for being applied to entrance and exit of small shops or stores. Thereby the shortcoming of the conventional RFID gate antenna that it is unable to be used in small shops or stores is overcome.

### BACKGROUND OF THE INVENTION

### Field of the Invention

The present invention relates to a radio frequency identification (RFID) gate, especially to a RFID gate antenna.

### Description of Related Art

Nowadays goods on open shelves in shopping malls are generally disposed with Electronic Article Surveillance Systems (EAS Systems) for monitoring and preventing shoplifting. The EAS system is mainly composed of detectors, a deactivator and electronic tags. There are several major types of EAS systems including magnetic systems, radio frequency systems (RF System), electromagnetic systems and microwave systems. The RF systems and the magnetic systems are commonly used. The RF system benefits the user in terms of low installation cost. Electronic tags disposed with receiving antennas and used for storage of digital information (such as product information) are attached to the goods respectively. RFID tags are one of the most common electronic tags for preventing shoplifting and inventory management.

A common Radio Frequency Identification (RFID) gate detector available at every entrance and exit in shopping malls includes a signal transmitter and a signal receiver. The transmitter antenna and the receiver antenna transmits and receives radio frequency signals in specific frequency range respectively and continuously for interrogating tags on items while customers carry the items and pass through the RFID gate. An alarm sounds if customers have unpaid-for items while passing near the RFID gate. On the other hand, the items have been paid for will not trigger the alarm while passing near the RFID gate.

There are some technical problems involved in the use of RFID gate (such as UHF RFID gate) in intelligent convenience stores or self-service stores now. The read range of UHF RFID tags is up to several meters. The UHF RFID reader antenna available now in the RFID gate easily scans all tags within the range including tags on people or shelves nearby so that the RFID gate doesn't work well. Thereby the conventional RFID gate is difficult to be used in limited space of small shops or self-service shops.

### SUMMARY OF THE INVENTION

Therefore it is a primary object of the present invention to provide a RFID gate antenna suitable for small shops or self-service stores with limited space.

In order to achieve the above object, a RFID gate antenna according to the present invention includes a dielectric layer, a patch layer and a ground layer. The dielectric layer is a sheet-like part made from dielectric material and having a surface. An inner surface is disposed on one side of the dielectric layer and an outer surface is arranged at the other side of the dielectric layer, opposite to the inner surface. The inner surface is a surface located on one side of the dielectric layer and facing the center of curvature. The patch layer arranged with a feed point is attached to the inner surface of the dielectric layer. The ground layer is attached to the outer surface of the dielectric layer, opposite to the patch layer.

The present RFID gate antenna can be a patch antenna.

Both the patch layer and the ground layer are made from either metals or conductive ink. The metals can be copper, aluminum, iron, or an alloy formed by a combination thereof while the conductive ink includes silver paste, copper paste, aluminum paste, carbon paste and a composite conductive ink formed by a combination thereof.

The dielectric layer is made from foamed plastic or foamed plastic filled with high dielectric constant powder. Materials for the foamed plastic include polyvinyl chloride (PVC), polystyrene (PS), polyurethane (PU), and urea-formaldehyde (UF).

The surface of the dielectric surface is a paraboloid.

The dielectric layer can be a semi-cylindrical sheet-like part.

The dielectric layer can be a hemispherical sheet-like part.

The present RFID gate antenna features on that both detecting angle and directivity of the RFID gate antenna are modified for being applied to entrance and exit of small shops or stores. Thus the problem of the conventional RFID gate antenna that it is unable to be used in small shops or stores is solved.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an explosive view of an embodiment of a RFID gate antenna according to the present invention;

FIG. 2 is a perspective view of the embodiment in FIG. 1 according to the present invention;

FIG. 3 is a cross sectional view taken along the line A-A in FIG. 2 according to the present invention;

FIG. 4 is a perspective view of another embodiment of a RFID gate antenna according to the present invention;

FIG. 5 is a cross sectional view taken along the line B-B in FIG. 4 according to the present invention;

FIG. 6 is a cross sectional view of a further embodiment of a RFID gate antenna according to the present invention;

FIG. 7 is a schematic drawing showing an embodiment of a RFID gate antenna in use according to the present invention.

### DETAILED DESCRIPTION OF THE PREFERRED EMBODIMENT

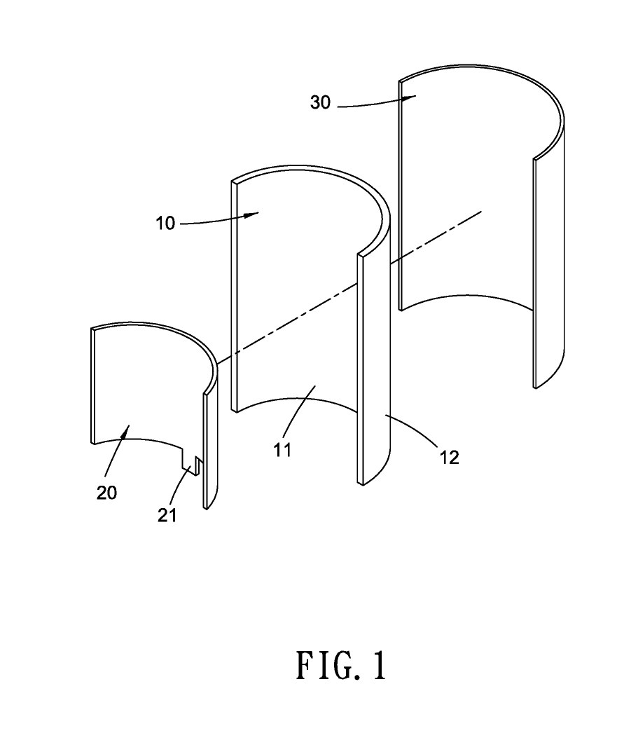

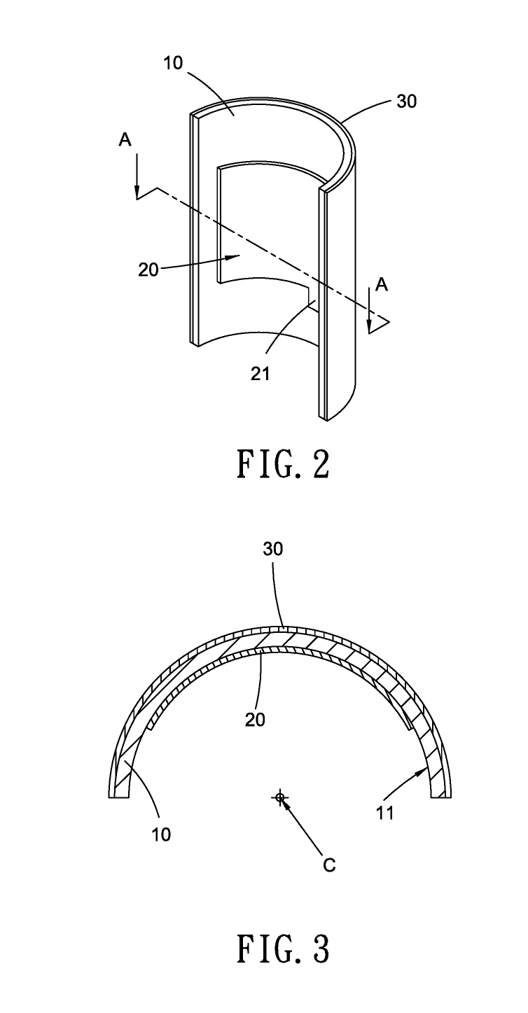

Refer to FIG. 1, FIG. 2 and FIG. 3, a RFID gate antenna according to the present invention includes a dielectric layer 10, a patch layer 20 and a ground layer 30. The present RFID gate antenna is a patch antenna used as a radio transmitter and receiver of a RFID gate.

The dielectric layer 10 is a sheet-like part made from dielectric material and having a surface. An inner surface 11 is disposed on one side of the dielectric layer 10 and an outer surface 12 is arranged at the other side of the dielectric layer 10, opposite to the inner surface 11. The inner surface 11 is a surface located on one side of the dielectric layer 10 and facing the center of curvature C of the surface of the dielectric layer 10. The patch layer 20 disposed with a feed point 21 is attached to the inner surface 11 of the dielectric layer 10 and is used as a radiator for radiating power (generally called patch antenna). In this embodiment, the patch layer 20 shown in FIG. 1 is, but not limited to, a circularly polarized rectangular patch antenna. The ground layer 30 is attached to the outer surface 12 of the dielectric layer 10, opposite to the patch layer 20, and is electrically connected to ground (earth).

The dielectric layer 10 is made from foamed plastic or foamed plastic filled with high dielectric constant powder, which is able to be shaped into a sheet-like part with a surface by molding. Materials for the foamed plastic include polyvinyl chloride (PVC), polystyrene (PS), polyurethane (PU), and urea-formaldehyde (UF). Materials for the patch layer 20 and the ground layer 30 can be either metals or conductive ink. The metals can be copper, aluminum, iron, or an alloy formed by a combination thereof. The conductive ink includes silver paste, copper paste, aluminum paste, carbon paste and a composite conductive ink formed by a combination thereof. The patch layer 20 and the ground layer 30 can be attached to the inner surface 11 or the outer surface 12 of the dielectric layer 10 respectively by various ways such as electroplating, printing, adhesion, etc.

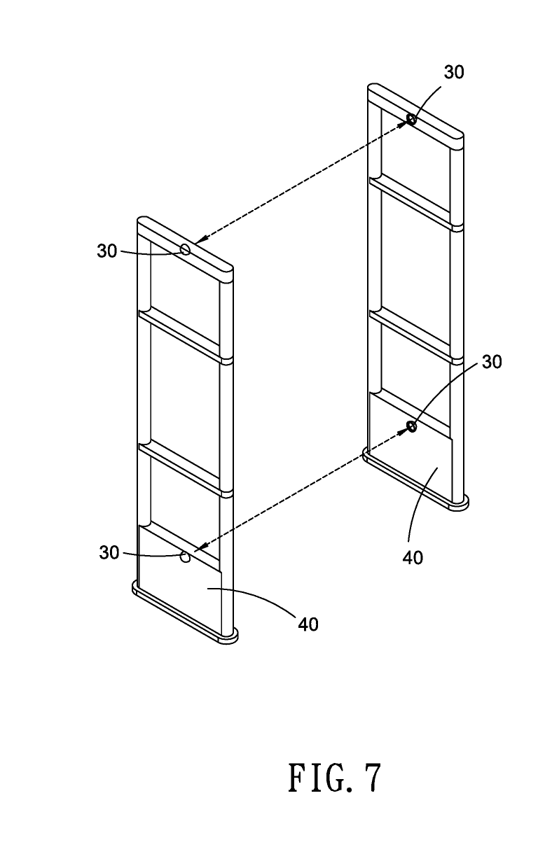

In the embodiment shown in FIG. 1, the dielectric layer 10 is a semi-cylindrical sheet-like part. Refer to FIG. 7, a RFID gate antenna is disposed on a frame 40 and the inner surface 11 of the dielectric layer 10 is aligned with a preset direction of propagation of electromagnetic waves for modification of detecting angle and directivity of the RFID gate antenna. Thus the effective transmission/reception angle of the antenna can be limited in a certain range such as passages of shops or in shopping malls, without reading tags on shelves nearby and working inaccurately. Therefore the problem of the conventional RFID gate that it is unable to be used in small shops or stores is solved.

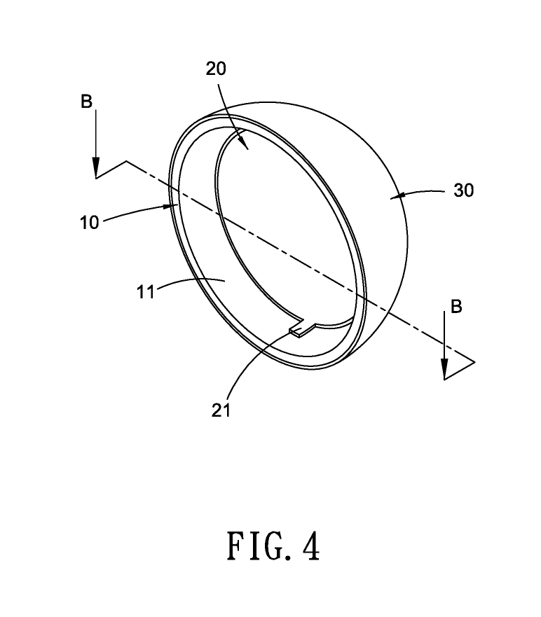

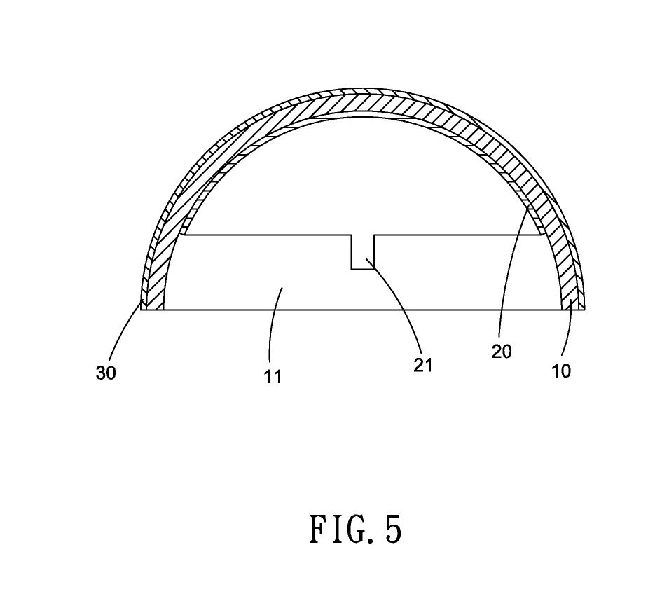

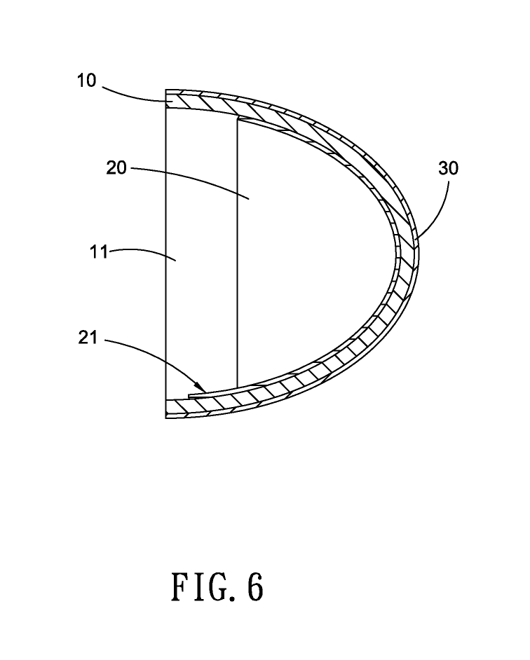

Refer to FIG. 4 and FIG. 5, another embodiment of a RFID gate antenna is revealed. The dielectric layer 10 is a hemispherical sheet-like part. Refer to FIG. 6, a further embodiment is disclosed and the surface of the dielectric layer 10 (including the inner surface 11 and the outer surface 12) thereof is a paraboloid.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A radio-frequency identification (RFID) gate antenna used as a radio transmitter and receiver of a RFID gate comprising:
a dielectric layer that is a sheet-like part with a surface, made from dielectric material, and including an inner surface on one side thereof and an outer surface on the other side thereof, opposite to the inner surface; the inner surface is facing the center of curvature of the surface of the dielectric layer;
a patch layer that is attached to the inner surface of the dielectric layer and is disposed with a feed point; and
a ground layer that is attached to the outer surface of the dielectric layer, opposite to the patch layer.

2. The device as claimed in claim 1, wherein the RFID gate antenna is a patch antenna.

3. The device as claimed in claim 1, wherein a material for the patch layer and the ground layer is selected from the group consisting of copper, aluminum, iron, a combination thereof and conductive ink.

4. The device as claimed in claim 3, wherein the conductive ink is selected from the group consisting of silver paste, copper paste, aluminum paste, carbon paste and a combination thereof.

5. The device as claimed in claim 1, wherein the dielectric layer is made from foamed plastic; a material for the foamed plastic is selected from the group consisting of polyvinyl chloride (PVC), polystyrene (PS), polyurethane (PU), and urea-formaldehyde (UF).

6. The device as claimed in claim 1, wherein the dielectric layer is made from foamed plastic filled with high dielectric constant powder; a material for the foamed plastic is selected from the group consisting of polyvinyl chloride (PVC), polystyrene (PS), polyurethane (PU), and urea-formaldehyde (UF).

7. The device as claimed in claim 1, wherein the surface of the dielectric surface is a paraboloid.

8. The device as claimed in claim 1, wherein the dielectric layer is a semi-cylindrical sheet-like part.

9. The device as claimed in claim 1, wherein the dielectric layer is a hemispherical sheet-like part.
